(19) United States
(12) Patent Application Publication
(10) Pub. No.: US 2012/0076351 A1
(43) Pub. Date: Mar. 29, 2012

(54) COOKER AND CONTROL METHOD THEREOF

(76) Inventors: Yoo-Sool Yoon, Seoul (KR); Jeong-Hyun Lim, Seoul (KR); Koon-Seok Lee, Seoul (KR)

(21) Appl. No.: 13/376,792

(22) PCT Filed: Jun. 15, 2010
(86) PCT No.: PCT/KR2010/003844

§ 371 Date: Dec. 7, 2011

(30) Foreign Application Priority Data
Jun. 15, 2009 (KR) 10-2009-0053050

(51) Int. Cl. G06K 9/00

(52) U.S. Cl. 382/100

(57) ABSTRACT

Provided is a cooker. An image of the inside of a cooking chamber scanned by an image sensor is displayed to the outside through a display part. Thus, a user may more easily and accurately recognize the inner state of the cooking chamber.

### TECHNICAL FIELD

The present disclosure relates to a cooker, and more particularly, to a cooker for scanning food to display a food image.

### BACKGROUND ART

Cookers are home appliances for cooking food with electricity or gaseous fuel. Such a cooker includes a heat source for heating food in a cooking chamber. The cooker also includes a temperature sensor or a humidity sensor for sensing temperature or humidity of the cooking chamber. An operation of the heat source is controlled according to a temperature or humidity sensed by the temperature sensor or the humidity sensor, thereby facilitating the cooking of the food in the cooking chamber.

### DISCLOSURE

### Technical Problem

Embodiments provide a cooker that more accurately detects an inner state of a cooking chamber.

Embodiments also provide a cooker in which a user more easily recognizes an inner state of a cooking chamber.

### Technical Solution

In one embodiment, a cooker includes: a main body including a cooking chamber in which food is cooked; a door selectively opening and closing the cooking chamber; a heat source providing heat for heating the food in the cooking chamber; an image sensor scanning the food in the chamber; a display part displaying an image of the food scanned by the image sensor; and a control part determining a cooked degree and whether the cooking is finished from the image of the food scanned by the image sensor to control an operation of the heat source.

In another embodiment, a cooker includes: a main body including a cooking chamber in which food is cooked; a door selectively opening and closing the cooking chamber; a heat source providing heat for heating the food in the cooking chamber; an image sensor scanning the food in the chamber; a display part displaying an image of the food scanned by the image sensor; and a communication part transmitting/receiving data into/from an external terminal; a data storage part storing data according to a kind of food; and a control part determining the kind of food cooked in the cooking chamber from an image of the food scanned by the image sensor to transmit data corresponding to the food of the data stored in the data storage part into the terminal through the communication part according to the determined kind of food.

The details of one or more embodiments are set forth in the accompanying drawings and the description below. Other features will be apparent from the description and drawings, and from the claims.

### Advantageous Effects

According to the embodiments, the user may more easily and accurately recognize the inner state of the cooking chamber.

### DESCRIPTION OF DRAWINGS

FIG. 1 is a perspective view of a cooker according to an embodiment.

FIG. 2 is a schematic view of a cooker according to a first embodiment.

FIG. 3 is a perspective view of a cooker according to a second embodiment.

FIG. 4 is a schematic view illustrating a state in which the cooker according to the embodiment is connected to a network according to a third embodiment.

### MODE FOR INVENTION

Hereinafter, a cooker according to a first embodiment will be described in detail with reference to accompanying drawings.

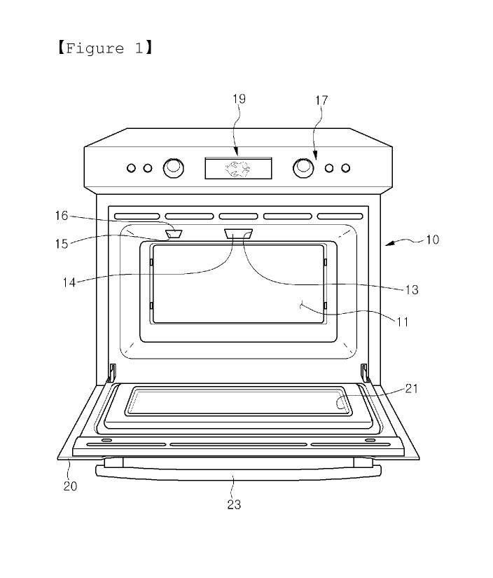

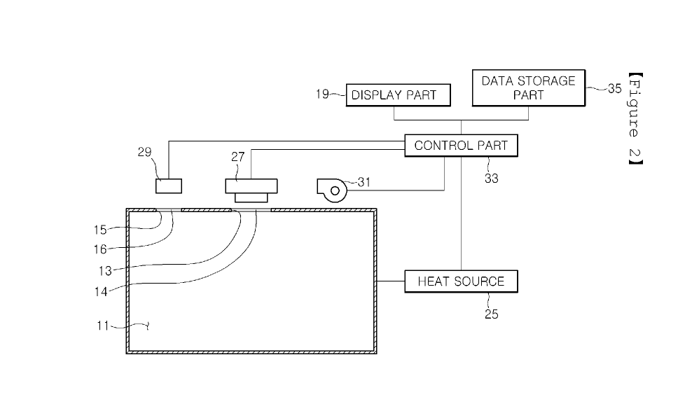

FIG. 1 is a perspective view of a cooker according to an embodiment. FIG. 2 is a schematic view of a cooker according to a first embodiment.

Referring to FIGS. 1 and 2, a cooker according to the current embodiment includes a main body 10 that accommodates a cooking chamber 11. The cooking chamber 11 provides a space for cooking food.

A sensing opening 13 is defined at a side of a top surface of the cooking chamber 11. A shield glass 14 is disposed in the sensing opening 13. The position of the sensing opening 13 is not limited to the top surface of the cooking chamber 11. For example, the sensing opening 13 may be defined in one of both side surfaces of the cooking chamber 11 or a rear surface of the cooking chamber 11. A lighting opening 15 is defined at a side of the top surface of the cooking chamber 11.

Also, a shield glass 16 is disposed in the sensing opening 15. Although the lighting opening 15 is disposed at a side of the top surface of the cooking chamber 11 adjacent to the sensing opening 13, the present disclosure is not limited thereto.

An input part 17 and a display part 19 are disposed on a front upper portion of the main body 10 corresponding to an upper side of the cooking chamber 11. The input part 17 receives a manipulation signal for operating the cooker. The display part 19 displays an inner state of the cooking chamber detected by an image sensor 27 to be described later. Although the input part 17 and the display part 19 are disposed on the front upper portion of the main body 10, the present disclosure is not limited thereto. For example, the input part 17 and the display part 19 may be disposed on the front left and right portions of the main body 10.

The cooking chamber 11 is selectively opened and closed by a door 20. The front end of the door 20 rotates about a vertical axis thereof in front and rear directions of the main body 10. A viewing window 21 is disposed in the door 20. A user may directly see the inner state of the cooking chamber through the viewing window 21. For example, a central portion of the door 20 may be formed of a transparent or translucent material to provide the viewing window 21. Also, a door handle 23 to be grasped by the user is disposed on a front upper end of the door 20 to open and close the door 20.

A heat source 25 is disposed in the main body 10. The heat source 25 heats food in the cooking chamber 11. For example, the heat source 25 may include at least one of a high frequency heat source emitting microwaves into the cooking chamber 11 and a radiant heat source and convection heat source respectively supplying radiant heat and convection heat into the cooking chamber 11.

The image sensor 27 is disposed in the main body 10. The image sensor 27 scans the inside of the cooking chamber 11, i.e., food received in the cooking chamber 11. In the current embodiment, the image sensor 27 is disposed at an upper side of the main body 10, i.e., an upper side of the cooking chamber 11 corresponding to an upper side of the sensing opening 13 provided with the shield glass 14.

Also, a lamp 29 is disposed in the main body 10. The lamp 29 illuminates the inside of the cooking chamber 11. The lamp 29 is disposed above the lighting opening 15.

A cooling fan 31 disposed in the main body 10 is adjacent to the image sensor 27. The cooling fan 31 generates an air flow for cooling the image sensor 27. Although the cooling fan 31 is separately provided to cool the image sensor 27 in the current embodiment, the image sensor 27 may be cooled by a cooling fan (not shown) for cooling the heat source 25.

A control part 33 controls operations of the heat source 25, the image sensor 27, and the display part 19. In detail, the control part 33 controls an operation of the heat source 25 according to a manipulation signal inputted into the input part 17. The control part 33 controls the image sensor 27 to scan food and controls the display part 19 to display an image of the scanned food. Here, the control part 33 controls the image sensor 27 to scan the food in real time before the heat source 25 is operated and controls the image sensor 27 to stop the operation of the image sensor 27 after the heat source 25 is stopped. The control part 33 also controls the display part 19 to operate the display part 19 when the image sensor 27 is operated. Thus, the operations of the display part 19 and the image sensor 27 may simultaneously start and simultaneously stop. Also, the control part 33 determines a cooked degree of the food and whether the cooking is finished through the food image scanned by the image sensor 27 to control an operation of the heat source 25.

In the current embodiment, the control part 33 reads an RGB color value of the food from the food image scanned by the image sensor 27 to determine a cooked degree of the food according to a variation depending on an elapsed time in the read RGB color value of the food. Here, the control part 33 compares the variation of the read RGB color value of the food to a variation of a reference RGB color value to control an output of the heat source 25. For example, the control part 33 controls the heat source 25 to increase the output of the heat source 25 when the variation of the read RGB color value is less than that of the reference RGB color value. Also, the control part 33 controls the heat source 25 to increase the output of the heat source 25 when the variation of the read RGB color value is greater than that of the reference RGB color value.

The control part 33 determines that the cooking of the food is finished when the read RGB color value of the food reaches a preset finish RGB color value. Thus, the control part 33 controls the heat source 25 to stop the operation of the heat source 25 when the read RGB color value of the food reaches the finish RGB color value.

Here, the reference RGB color value variation and the finish RGB color value represent a variation of the RGB color value of the food depending on an elapsed time in the cooking process of the food according to a kind of food and a RGB color value of the food in a state where the cooking of the food is finished, respectively. For example, in case where the food is meat, a RGB color value having a relatively high R value is read before the operation of the heat source 25 starts, i.e., before the cooking. However, when the meat is cooked and done by the operation of the heat source 25, a RGB color value having a relatively high Y value is read as the RGB color value of the meat. When the food is cooled by the operation of the heat source 25, the RGB color value of the meat decrease in R value and increase in Y value.

The control part 33 controls operations of the lamp 29 and the cooling fan 31. In the current embodiment, the control part 33 controls the lamp 29 and the cooling fan 31 to operate the lamp 29 and the cooling fan 31 before the image sensor 27 is operated or when the image sensor 27 is operated. Also, the control part 33 controls the lamp 29 and the cooling fan 31 to stop the operations of the lamp 29 and the cooling fan 31 when the operation of the image sensor 27 is stopped or after the operation of the image sensor 27 is stopped.

The refrigerant RGB color value variation and the finish RGB color value are stored in a data storage part 35. Here, the data storage part 35 stores the reference RGB color value variation and the finish RGB color value according to the kind of food.

Hereinafter, an operation of the cooker according to the first embodiment will be described in detail with reference to accompanying drawings.

The user rotates the door 20 to shield the cooking chamber 11 in a state where the food is received into the cooking chamber 11. Then, when the user manipulates the input part 17 to input a manipulation signal for cooking the food, the control part 33 controls the heat source 25 to operate the heat source 25. Thus, the food is cooked in the cooking chamber 11.

The control part 33 controls the image sensor 27 and the lamp 29 to operate the image sensor 27 and the lamp before an operation of the heat source 25 starts. Thus, the image sensor 27 scans the inner portion of the cooking chamber 11 in real time. An image of the food scanned by the image sensor 27 is displayed through the display part 19. The control part 33 controls the cooling fan to operate the cooling fan, thereby cooling the image sensor 27.

Here, the control part 33 reads a RGB color value of the food from the food image scanned by the image sensor 27 to compare a variation depending on an elapsed time to the reference RGB color value variation, thereby maintaining, increasing, or decreasing an output of the heat source 25.

Then, the control part 33 determines whether the read RGB color value of the food reaches the finish RGB color value. When the control part 33 determines that the read RGB color value of the food reaches the finish RGB color value, the control part 33 controls the heat source 25 to stop the operation of the heat source 25. When the operation of the heat source 25 is stopped, the control part 33 controls the image sensor 27, the lamp 29, and the cooling fan 31 to stop the operations of the image sensor 27, the lamp 29, and the cooling fan 31.

The control part 33 controls the display part 19 to display the food image scanned by the image sensor 27 through the display part 19. Thus, the user may easily determine the cooked degree of the food and whether the cooking is finished in the cooking chamber 11 from the food image displayed on the display part 19.

Hereinafter, a cooker according to a second embodiment will be described in detail with reference to accompanying drawings.

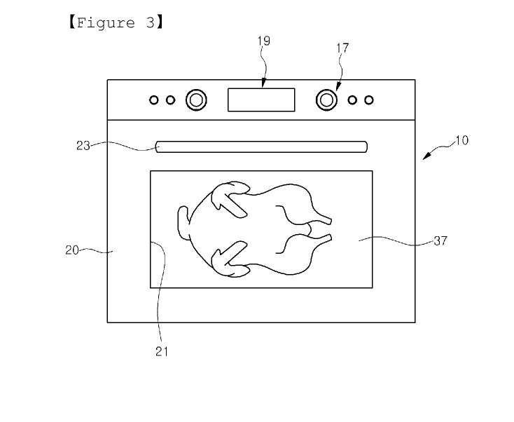

FIG. 3 is a perspective view of a cooker according to a second embodiment. Here, the same components as those of the foregoing first embodiment will be denoted by the same reference numerals as those of FIGS. 1 and 2 and their detained descriptions will be omitted.

Referring to FIG. 3, an image display part 37 for displaying an image of food scanned by an image sensor 27 is disposed on a door 20. In detail, the image display part 37 is disposed at a center corresponding to the viewing window (see reference numeral 21 of FIG. 1) according to the foregoing first embodiment. Thus, the image display part 37 according to the current embodiment may have a size relatively greater than that of the display part (see reference numeral 19 of FIG. 1) according to the foregoing first embodiment.

This is done for a reason that enables the user to see a more large food image scanned by the image sensor (see reference numeral 27 of FIG. 2). Also, this is done for a reason that prevents the foods from being inaccurately distinguished through the viewing window 21 due to dew formed on the viewing window 21 in the cooking process of the food.

Hereinafter, a cooker according to a third embodiment will be described in detail with reference to accompanying drawings.

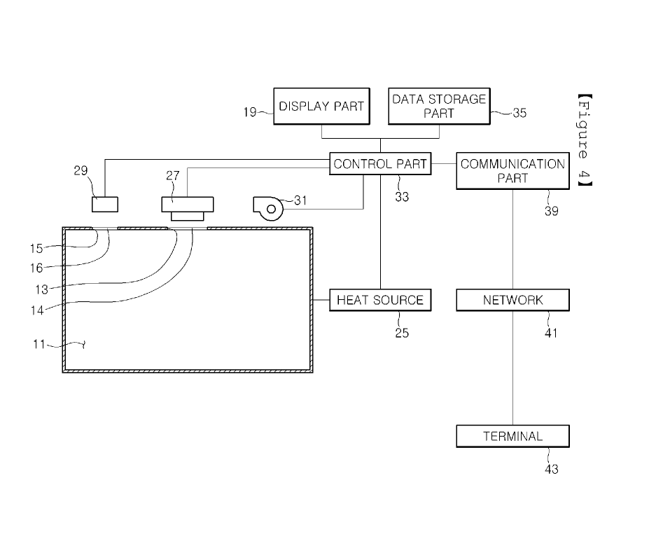

FIG. 4 is a schematic view illustrating a state in which the cooker according to the embodiment is connected to a network according to a third embodiment. Here, the same components as those of the foregoing first embodiment will be denoted by the same reference numerals as those of FIGS. 1 and 2 and their detained descriptions will be omitted.

Referring to FIG. 4, a cooker according to the current embodiment includes a cooking chamber 11 in which food is cooked by a heat source 25. An image sensor 27 scans the food in the cooking chamber 11 to form a food image. Then, a display part 19 displays the food image scanned by the image sensor 27. A control part 33 controls operations of the image sensor 27 and the display part 19.

A data storage part 35 stores a reference RGB color value variation and a finish RGB color value according to a kind of food. In the current embodiment, the data storage part 35 may storage recipes and character images transmitted from a terminal 43 that will be described later. Here, the character images may be changed according to a cooking process of the food in the cooking chamber 11.

The cooker according to the current embodiment further includes a communication part 39 communicating with the terminal 43 through a network 41. The communication part 39 of the cooker transmits information including the food image scanned by the image sensor 27 into the terminal 43 through the network 41 and receives information from the terminal 43 to transmit the received information.

The network 41 connects the communication part 39 of the cooker to the terminal 43. The network 41 may connect wirelessly the communication part 39 to the terminal 43 or connect the communication part 39 to the terminal 43 through a wired cable. The terminal 43 transmits and receives data into/from the cooker through the network 41 at a remote area spaced from the cooker.

For example, the cooker transmits the food image scanned by the image sensor 27 into the terminal 43. Also, the terminal 43 transmits an operation of the cooker, i.e., a manipulation signal for controlling an operation of the heat source 25 into the cooker. The cooker transmits data stored in the data storage part 35, i.e., the recipes and character images into the terminal 43. Here, the control part 33 reads a RGB color value from the food image scanned by the image sensor 27 to determine a kind of food. Thus, the control part 33 controls the cooker to transmit the recipes and character images from the cooker to the terminal 43 according to the determined kind of food. That is, the controls determines a kind of food received in the cooking chamber 11 from the read RGB color value of the food to transmit the recipes and character images to the terminal 43 according to the determined kind of food.

The terminal 43 includes a communication part 39 for communicating with the cooker to transmit/receive data between the cooker and the terminal 43. The terminal 43 includes a display part for displaying the food image and an input part for inputting the manipulation signal. Here, separate terminals for a computer, mobile phone, the display part 19, and the input part 17 are used as the terminal 43.

It should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims.

### INDUSTRIAL APPLICABILITY

As described above, the cooker according to the embodiments has effects as follows.

The food image scanned by the image sensor may be displayed to the outside. Thus, the user may more accurately recognize a state of the food.

Also, the cook image scanned by the image sensor may be wirelessly transmitted into the user disposed at a position spaced from the cooker or transmitted into the user through wired communication. Thus, the user may more accurately recognize a state of the food.

Also, the display part for displaying the cook image scanned by the image sensor may be disposed on the front surface of the door for selectively opening and closing the cooking chamber. Thus, the display part may be easily designed in position.

1.-19. (canceled)

20. A cooker comprising:
a cooking chamber in which food is cooked;
a door selectively opening and closing the cooking chamber;
a heat source providing heat for heating the food in the cooking chamber;
an image sensor scanning the food in the chamber;
a display part displaying an image of the food scanned by the image sensor; and
a control part determining a cooked degree and whether the cooking is finished from the image of the food scanned by the image sensor to control an operation of the heat source.

21. The cooker according to claim 20, wherein the control part reads a RGB color value of the food from the image of the food scanned by the image sensor to determine the cooked degree of the food according to a variation of the read RGB color value of the food according to an elapsed time.

22. The cooker according to claim 21, wherein the control part controls the heat source to increase heat provided from the heat source into the cooking chamber when the variation of the read RGB color value of the food is less than a preset reference RGB color value variation and to decrease heat provided from the heat source into the cooking chamber when the variation of the read RGB color value of the food exceeds the reference RGB color value variation.

23. The cooker according to claim 21, wherein the control part stops an operation of the heat source when the read RGB color value of the food reaches a preset finish RGB color value.

24. The cooker according to claim 20, further comprising a communication part for transmitting/receiving data into/from an external terminal.

25. The cooker according to claim 24, wherein the data transmitted into the terminal by the communication part comprises an image of the food scanned by at least the image sensor.

26. The cooker according to claim 24, wherein the data received from the terminal by the communication part comprises a manipulation signal for controlling an operation of the heat source.

27. The cooker according to claim 20, wherein control part determines a kind of food cooked in the cooking chamber from the image of the food scanned by the image sensor before an operation of the heat source starts.

28. The cooker according to claim 27, wherein the control part reads a RGB color value of the food from the image of the food scanned by the image sensor to determine a kind of food according to the read RGB color value of the food.

29. The cooker according to claim 27, further comprising:
a data storage part storing data according to a kind of food; and
a communication part transmitting/receiving data into/from an external terminal,
wherein the control part controls the communication part to transmit data corresponding to the determined food of the data stored in the data storage part into the terminal.

30. The cooker according to claim 29, wherein the data stored in the data storage part comprises at least recipe of the food and at least character image changed according to a cooking process of the food.

31. The cooker according to claim 27, wherein the communication part is connected wirelessly to the terminal or connected the terminal through a wired cable.

32. A method of controlling a cooker, the method comprising:
scanning an image of food through an image sensor;
providing heat for heating the food from a heat source;
reading a RGB color value of the food changed by the heat provided by the heat source from the image of the food scanned by the image sensor through a control part;
determining a cooked degree of the food according to a variation of the read RGB color value of the food depending on an elapsed time through the control part; and
controlling an operation of the heat source according to the determined cooked degree of the food through the control part.

33. The method according to claim 32, wherein the control part controls the heat source to increase heat provided from the heat source into the cooking chamber when the variation of the read RGB color value of the food is less than a preset reference RGB color value variation and to decrease heat provided from the heat source into the cooking chamber when the variation of the read RGB color value of the food exceeds the reference RGB color value variation.

34. The method according to claim 33, wherein the control part stops an operation of the heat source when the read RGB color value of the food reaches a preset finish RGB color value.

35. The method according to claim 32, further comprising transmitting data comprising the image of the food scanned by at least the image sensor into an external terminal through the communication part.

36. The method according to claim 32, further comprising scanning an image of the food in a cooking chamber through the image sensor before the heat source is operated.

37. The method according to claim 36, further comprising transmitting data comprising the image of the food scanned by the image sensor into an external terminal through a communication part.

38. The cooker according to claim 37, wherein the data transmitted into the terminal through the communication part comprises at least recipe of the food and at least character image changed according to a cooking process of the food.
